(19) United States
(12) Patent Application Publication
(10) Pub. No.: US 2025/0231782 A1
(43) Pub. Date: Jul. 17, 2025

(54) ELECTRONIC DEVICE CAPABLE OF PROPOSING CONTEXTUAL BEHAVIOR PATTERN AND CONTROL METHOD THEREFOR

(71) Applicant: SAMSUNG ELECTRONICS CO., LTD., Suwon-si (KR)

(72) Inventors: Hoon HAN, Suwon-si (KR); Hyunjin KIM, Suwon-si (KR); Yoonsu KIM, Suwon-si (KR); Haeyoon PARK, Suwon-si (KR)

(21) Appl. No.: 19/097,522

(22) Filed: Apr. 1, 2025

Related U.S. Application Data
(63) Continuation of application No. PCT/KR2023/012287, filed on Aug. 18, 2023.

(30) Foreign Application Priority Data
Oct. 18, 2022 (KR) 10-2022-0134254

(51) Int. Cl. G06F 9/451; G16Y 40/35; H04L 12/28

(52) U.S. Cl. CPC G06F 9/453; H04L 12/282; G16Y 40/35

(57) ABSTRACT

The present disclosure relates to an electronic device and control method. The method includes obtaining situation information through a pre-defined situation recognition method; determining any one of a plurality of behavior patterns as a predicted behavior pattern on the basis of the situation information; generating a main query on the basis of at least one of the situation information and the predicted behavior pattern; outputting, on a display, a first virtual button corresponding to the situation information, a second virtual button corresponding to the predicted behavior pattern, and the main query; on the basis of receiving a negative response to the main query, activating the first virtual button and second virtual button; and on the basis of a user input on the first virtual button or second virtual button, updating any one of a mapping relationship between the situation information and the predicted behavior pattern, and the situation recognition method.

### CROSS-REFERENCE TO RELATED APPLICATIONS

This application is a by-pass continuation application of International Application No. PCT/KR2023/012287 filed on Aug. 18, 2023, which is based on and claims priority to Korean Patent Application No. 10-2022-0134254 filed on Oct. 18, 2022, in the Korean Intellectual Property Office, the disclosures of which are incorporated by reference herein their entireties.

### BACKGROUND

### Technical Field

The disclosure relates to an electronic device capable of suggesting a behavior pattern for each situation and a method for controlling the same.

### Description of the Related Art

The Internet of Things (IoT) refers to technology for accessing the Internet by equipping various things with computer chips and communication features. An IoT device may be a general device (or thing) to which the IoT is applied. For example, IoT devices may include various sensors, such as temperature sensors, humidity sensors, sound sensors, motion sensors, proximity sensors, gas detection sensors, and heat detection sensors, various home appliances, such as refrigerators, CCTVs, TVs, washers, and dehumidifiers, lights, fire alarms, and home devices.

Meanwhile, as various IoT devices and a terminal are connected through a network, the IoT devices may suggest the user to execute an appropriate behavior according to the user's life pattern even without separate user control. To that end, the IoT devices or the terminal senses the user's interest, life pattern, and psychological state and record and manage them in a memory or an external server.

### SUMMARY

The disclosure provides a method for receiving detailed feedback for each factor used in a process of determining a behavior pattern to recommend an adaptive behavior pattern to a user and an electronic device for performing the method.

A control method by an electronic device according to an embodiment may comprise obtaining situation information through a predefined situation recognition method, determining any one of a plurality of behavior patterns as an expected behavior pattern based on the situation information, generating a main query based on at least one of the situation information and the expected behavior pattern, outputting, on a display, a first virtual button corresponding to the situation information, a second virtual button corresponding to the expected behavior pattern, and the main query, activating the first virtual button and the second virtual button based on receiving a negative response to the main query, and updating any one of a mapping relationship between the situation information and the expected behavior pattern or the situation recognition method based on a user input to the first virtual button or the second virtual button.

In an embodiment, the user input to the first virtual button or the second virtual button may include a positive response or a negative response. The situation recognition method may be updated based on the user input to the first virtual button including a negative response. The mapping relationship may be updated based on the user input to the second virtual button including a negative response.

In an embodiment, the method may comprise identifying a first reliability value related to the situation information and a second reliability value related to the expected behavior pattern, and applying focusing to any one of the first virtual button or the second virtual button based on the first reliability value and the second reliability value.

In an embodiment, applying the focusing may include applying the focusing to the second virtual button based on the first reliability value being larger than the second reliability value, and applying the focusing to the first virtual button based on the second reliability value being larger than the first reliability value.

In an embodiment, the method may comprise, based on a user input to the focusing-applied virtual button of the first virtual button or the second virtual button including a positive response, applying the focusing to the other virtual button of the first virtual button or the second virtual button.

In an embodiment, the situation information may be received from an external device or obtained based on sensing information by one or more sensors.

In an embodiment, the plurality of behavior patterns may include at least one of one or more operations for controlling a behavior of the electronic device or one or more operations for controlling a behavior of another device connected to the electronic device through a network.

In an embodiment, the expected behavior pattern may include at least one of an independent behavior pattern or a dependent behavior pattern. The dependent behavior pattern may be performed with a lower priority than the independent behavior pattern.

In an embodiment, the method may comprise, when the expected behavior pattern includes two or more independent behavior patterns, outputting, on the display, two or more second virtual buttons respectively corresponding to the two or more independent behavior patterns.

In an embodiment, the method may comprise, based on receiving a negative response to any one of the two or more second virtual buttons, deleting a mapping relationship between the situation information and an independent behavior pattern associated with a second virtual button where the negative response may be received.

In an embodiment, the method may comprise, when the expected behavior pattern includes the independent behavior pattern and one or more dependent behavior patterns, outputting, on the display, two or more second virtual buttons respectively corresponding to the independent behavior pattern and the one or more dependent behavior patterns dependent on the independent behavior pattern.

In an embodiment, the method may comprise applying focusing to a second virtual button corresponding to any one of the one or more dependent behavior patterns, receiving a negative response to the focusing-applied second virtual button, and deleting the mapping relationship between the situation information and the dependent behavior pattern associated with the second virtual button where the negative response is received.

In an embodiment, the method may comprise applying focusing to a second virtual button corresponding to any one of the one or more dependent behavior patterns, receiving a positive response to the second virtual button corresponding to the dependent behavior pattern, and applying the focusing to the first virtual button based on receiving the positive response.

In an embodiment, the method may comprise applying focusing to a second virtual button corresponding to any one of the one or more dependent behavior patterns, receiving a positive response to the focusing-applied second virtual button, and applying the focusing to the first virtual button without applying the focusing to the second virtual button corresponding to the independent behavior pattern based on receiving the positive response.

An electronic device according to an embodiment may comprise a display, one or more memories, one or more transceivers, and one or more processors electrically connected to the display, the one or more memories, and the one or more transceivers. The one or more processors may perform obtaining situation information through a predefined situation recognition method, determining any one of a plurality of behavior patterns as an expected behavior pattern based on the situation information, generating a main query based on at least one of the situation information and the expected behavior pattern, outputting, on the display, a first virtual button corresponding to the situation information, a second virtual button corresponding to the expected behavior pattern, and the main query, activating the first virtual button and the second virtual button based on receiving a negative response to the main query, and updating any one of a mapping relationship between the situation information and the expected behavior pattern or the situation recognition method based on a user input to the first virtual button or the second virtual button.

According to various embodiments of the disclosure, it is possible to suggest an expected behavior pattern most appropriate for each situation information to the user by updating the expected behavior pattern according to given situation information. Further, it is possible to prevent an error from occurring later through the same route by grasping and excluding an error which may occur in a process of generating situation information.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIG. 1 is a view schematically illustrating an IoT system according to an embodiment;

FIG. 2 is a block diagram illustrating an electronic device applied to an IoT system according to an embodiment;

FIG. 3 is a flowchart illustrating a method for controlling an electronic device according to an embodiment;

FIG. 4 is a flowchart illustrating a focusing method of a virtual button applied to FIG. 3;

FIG. 5 is a reference view illustrating a control method according to an embodiment;

FIG. 6 is a reference view illustrating a control method according to an embodiment;

FIG. 7 is a reference view illustrating a control method according to an embodiment;

FIG. 8 is a reference view illustrating a voice control method according to an embodiment; and

FIG. 9 is a reference view illustrating a control method according to an embodiment.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

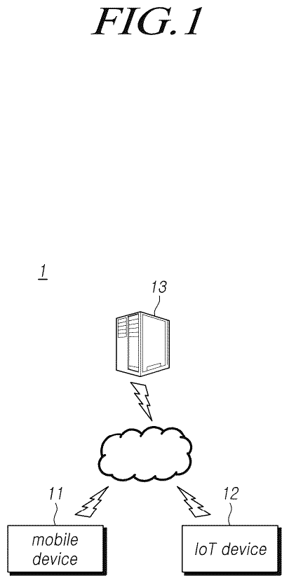

FIG. 1 is a view schematically illustrating an IoT system 1 according to an embodiment.

Referring to FIG. 1, an IoT system 1 may include a mobile device 11, a base station, and a network. The mobile device 11 means an electronic device that performs communication by radio access technology (e.g., 5G new radio (NR) or long-term evolution (LTE)), and may be referred to as a communication/mobile device. Although not limited thereto, the mobile device 11 may include a robot, a vehicle, an extended reality (XR) device, a portable device, a home appliance, an IoT device 12, and an artificial intelligence (AI) device.

The mobile device 11 may be connected to the network through the base station. The mobile device 11 may adopt AI technology and may be connected to an AI service server capable of providing AI services through the network.

The network may be configured as a 3G/4G/5G/6G network or the like. Mobile devices 11 may communicate with each other via the base station or network or directly (e.g., sidelink communication) without passing through the base station or network.

In an embodiment of the disclosure, the AI service server 13 may include an IoT service server. More specifically, the IoT service server may include a content recommendation server for recommending media content to the mobile device 11, a text-to-speech (TTS) server for analyzing user utterance, and a speech-to-text (STTP server for synthesizing text into voice. Further, the AI service server 13 may include a natural language processing (NLP) server or a natural language understanding (NLU) server for identifying the user's intent from the user utterance.

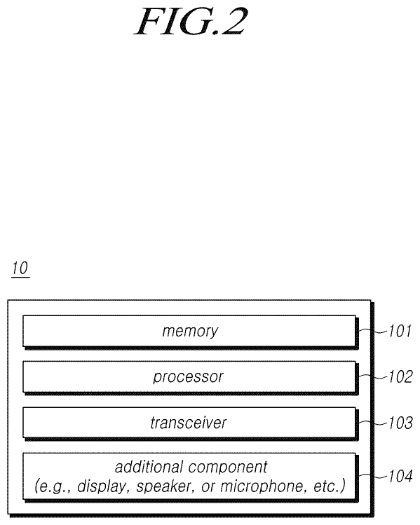

Various AI service servers 13 and mobile device(s) 11 that may be included in the IoT system 1 according to the disclosure may commonly include one or more memories, one or more communication units, and one or more controllers. Components of an electronic device applicable to the mobile device(s) 11 and the service server(s) 13 according to the disclosure are described below with reference to FIG. 2.

FIG. 2 is a block diagram illustrating an electronic device applied to an IoT system according to an embodiment.

The electronic device 10 according to various embodiments of the disclosure may include a processor 102, a memory 101, and a transceiver 103. The memory 101 and the transceiver 103 may be electrically or functionally connected to the processor 102. The processor 102 may control components constituting the electronic device 10 by generating and transmitting a control command.

According to various embodiments of the disclosure, the processor 102 may include a storage and processing circuit unit for supporting the operation of the electronic device 10. The storage and processing circuit unit may include storage, such as non-volatile memory 101 (e.g., flash memory, or other electrically programmable read only memory (ROM) configured to form a solid state drive (SSD)) or volatile memory (e.g., static or dynamic random access memory (RAM)). The processing circuit unit in the processor 102 may be used to control the operation of the electronic device 10. The processing circuit unit may be based on one or more microprocessor(s), microcontroller(s), digital signal processor(s), baseband processor(s), power management section(s), audio chip(s), or application specific integrated circuit(s).

According to various embodiments of the disclosure, the memory 101 may include a memory area for one or more processors 102 for storing variables used in the protocol, configuration, control, and other functions of the electronic device 10, including operations corresponding to or including any one of the methods and/or procedures described as an example in the disclosure. Further, the memory 101 may include non-volatile memory, volatile memory, or a combination thereof. Further, the memory 101 may interface with a memory slot that enables insertion and removal of removable memory cards in one or more formats (e.g., secure digital (SD) card, Memory stick, compact flash, etc.).

According to various embodiments of the disclosure, the transceiver 103 may include a wireless communication module or a radio frequency (RF) module. The wireless communication module may include, for example, wireless-fidelity (Wi-Fi), Bluetooth (BT), global positioning system (GPS) or near field communication (NFC). For example, the wireless communication module may provide a wireless communication function using a radio frequency. Additionally or alternatively, the wireless communication module may include a network interface or modem for connecting the electronic device 10 with a network (e.g., Internet, LAN, WAN, telecommunication network, cellular network, satellite network, POTS or 5G network). The RF module may be responsible for data transmission/reception, e.g., transmitting and receiving data RF signals or invoked electronic signals. As an example, the RF module may include, e.g., a power amp module (PAM), a frequency filter, or a low noise amplifier (LNA). The RF module may further include parts (e.g., conductors or wires) for communicating radio waves in a free space upon performing wireless communication.

In an embodiment, the electronic device 10 may further include an additional component 104. The additional component 104 may include, but is not limited to, e.g., an output unit, such as a display or a speaker, and an input unit, such as a microphone, a mouse, or a touchscreen.

Meanwhile, in an embodiment, the electronic device 10 may operate a virtual assistant. The virtual assistant may perform various functions for interacting with the user. For example, a virtual assistant may understand by uttering text as audio or processing the user's voice as natural language. The electronic device 10 may interact with the user in a voice conversation (or natural language) manner using the virtual assistant. The following operations may be performed using the virtual assistant provided in the electronic device 10.

In the disclosure, the virtual assistant may refer to any information processing system that interprets natural language in the form of speech and/or text to infer the user's intention and executes actions based on the inferred user intention. For example, to operate according to the inferred user intention, the system may execute one or more of the following: (a) identify the workflow using steps and parameters designed to achieve the inferred user intention, (b) input specific requirements from the inferred user intention into the workflow, (c) execute the workflow by invoking programs, methods, services, APIs, etc., and (d) generate output responses to the user in an audible (e.g., voice) and/or visible format.

In an embodiment, the virtual assistant may accept the user request at least partially in the form of a natural language command, request, statement, narrative, and/or inquiry. Typically, the user request seeks to obtain an informational answer or execution of a task which has information by the virtual assistant. The satisfactory response to the user request may include any one of provision of an answer having the requested information, execution of the requested task, or a combination of the two. For example, the user may ask a virtual assistant a question such as “Where am I now?” Based on the user's current location, the virtual assistant may answer, for example, “You are in Central Park.” The user may also request to execute a task, “Remind me to call my mother at 4PM today.” In response, the virtual assistant may acknowledge receipt of the request and then write a reminder item appropriate for the user's electronic schedule. During execution of the requested task, the virtual assistant may interact with the user in successive conversations involving multiple information exchanges, sometimes over an extended period of time. There are a number of different ways of interacting with the virtual assistant to request information or the execution of various tasks. In addition to providing verbal responses and taking programmed actions, the virtual assistant may also provide responses in other visual or audio formats (e.g., text, warning, music, video, animation, etc.) and possibly using multiple devices (e.g., outputting text through, as voice, a phone headset and displaying text on TV).

In an embodiment, the electronic device 10 may perform the following methods through one or more processors. The following method includes a plurality of operations, and each operation is not limited to being performed according to the order of description, but the order of the operations may rather be changed. In the following disclosure, the operation described as being performed by the electronic device 10 may be understood as being performed by a virtual assistant constituting at least a portion of the electronic device 10, or a virtual assistant wiredly/wirelessly connected to the electronic device 10.

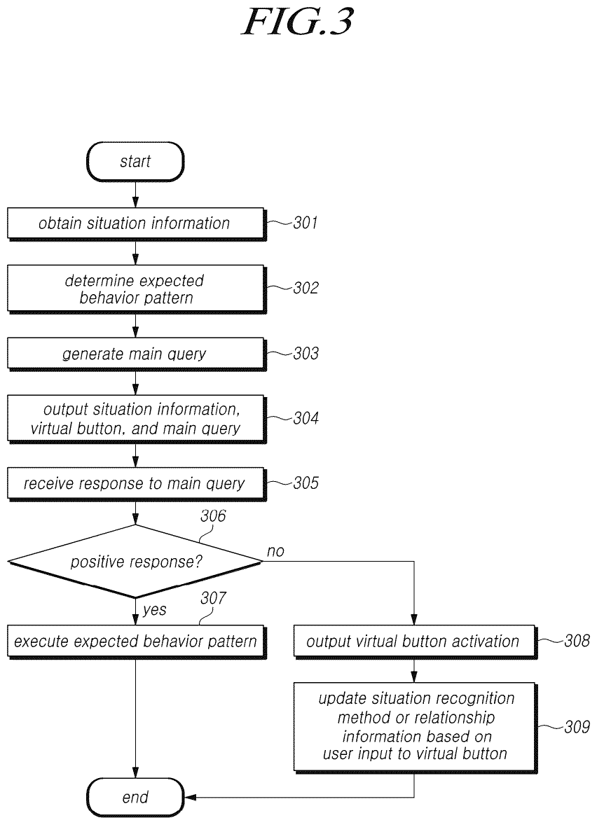

FIG. 3 is a flowchart illustrating a method for controlling an electronic device according to an embodiment.

In an embodiment, the electronic device may obtain situation information (at block 301).

In an embodiment, the electronic device may obtain situation information through a situation recognition unit provided therein. The situation recognition unit may include, e.g., various sensors such as an image sensor, a temperature sensor, an ultrasonic sensor, a lidar sensor, and a radar sensor. For example, the electronic device may recognize that the user is located in front of the electronic device through the situation recognition unit or that the user has moved to another location. The situation recognition unit may further include, e.g., one or more processors, and the situation recognition unit may generate situation information by processing the sensing information.

In an embodiment, the electronic device may receive situation information from an external device. The external device may be, e.g., any electronic device capable of wiredly/wirelessly communicating with the electronic device.

In an embodiment, the situation information may include user state information. The user state information is information indicating a current state of the user wearing or carrying the external device. The user state information may include, e.g., location information such as returning home or going out. The user state information may include, e.g., sleep state information such as going to bed and wake-up. The user state information may include, e.g., behavior information such as listening to the music or watching TV. Meanwhile, the user state information is not limited to the above-described examples.

In an embodiment, the situation information may include time information. The time information may include, e.g., time information such as night and day. The time information may include, e.g., day information such as weekends and weekdays. Meanwhile, the time information is not limited to the above-described examples.

In an embodiment, the situation information may be a combination of the user state information and the time information. For example, it may be combined, such as returning home on weekdays and going out on weekdays, but is not limited thereto.

In an embodiment, the electronic device may determine an expected behavior pattern according to the situation information (at block 302).

In an embodiment, the expected behavior pattern may be determined based on the situation information. The expected behavior pattern may be at least one of a plurality of predefined behavior patterns. The behavior patterns may include operations of controlling the electronic device, such as, e.g., a behavior of powering on a TV device, a behavior of changing the channel of the TV device, and a behavior of powering on an air conditioner.

In an embodiment, the electronic device may store the behavior patterns and situation information in the memory. Here, the behavior pattern may be associated with the situation information. More specifically, the situation information may be associated with one or more behavior patterns. In the disclosure, the relationship between the behavior pattern and the situation information may be referred to as relationship information. For example, if predetermined situation information is detected, the electronic device may detect an associated behavior pattern based on the relationship information.

As such, the electronic device may select one or more behavior patterns based on the situation information, and the selected behavior pattern may be referred to as an “expected behavior pattern”.

In an embodiment, the electronic device may generate a main query corresponding to the expected behavior pattern (at block 303).

In an embodiment, the main query may be a message asking whether to perform the expected behavior pattern. The main query may be generated based on at least one of the expected behavior pattern and/or situation information. For example, the main query may be constituted of a message asking whether to execute the expected behavior pattern. For example, the main query may be constituted of a message indicating the identified situation information and asking whether to execute the expected behavior pattern corresponding to the situation information.

In an embodiment, the query may be generated in the form of an interrogative sentence as to whether to execute the expected behavior pattern. For example, the query may be generated in the form of an interrogative sentence, such as “Do you want me to turn on your living room TV?” but is not limited thereto.

In an embodiment, the electronic device may output the main query through the output unit (at block 304).

For example, the electronic device may display the main query through the display, and the main query displayed through the display may be expressed in text form. For example, the electronic device may output the main query as a voice through the speaker, and the main query output through the speaker may be expressed in audio form.

In an embodiment, the electronic device may display, on the display, a virtual button indicating the situation information and/or the behavior pattern on which it is based to determine the expected behavior pattern (at block 304).

In an embodiment, the electronic device may output the main query while simultaneously displaying the virtual button on the display. For example, the electronic device may display the main query on the display and display the virtual button together on the display. For example, the electronic device may output the main query as a voice through the speaker and display the virtual button on the display.

In an embodiment, the electronic device may receive a response to the main query (at block 305).

The response to the main query may be received in the form of a user input. For example, the user may apply a user input through an input unit (e.g., touch screen, infrared sensor, microphone, etc.) provided in the electronic device, and the electronic device may or may not execute the expected behavior pattern according to the applied user input.

In an embodiment, the user input may include a positive response and a negative response.

In an embodiment, after checking that a positive response is received (at block 306), when the electronic device receives a positive response to the main query, the electronic device may execute the expected behavior pattern in response to receiving the positive response (block 306: YES; at block 307).

In this case, the electronic device may transmit one or more control commands to control to perform the expected behavior pattern to the external device capable of performing the expected behavior pattern. In an embodiment, the electronic device may perform the expected behavior pattern by itself.

In an embodiment, when the electronic device receives a negative response to the main query, the electronic device may not execute the expected behavior pattern in response to receiving the negative response (block 306: NO).

In an embodiment, the electronic device may activate the virtual button based on receiving a negative response to the main query (block 306: NO; at block 308).

In an embodiment, the virtual button may include a first virtual button and a second virtual button. The first virtual button graphically represents situation information that is the basis for determining the expected behavior pattern, and the second virtual button graphically represents the determined expected behavior pattern.

While the virtual button is activated, the electronic device may receive a user input to the virtual button. In other words, the electronic device may receive the user input through the virtual button.

In an embodiment, the electronic device may update the situation recognition method based on the user input to the activated first virtual button (at block 309).

The electronic device according to the disclosure determines the expected behavior pattern based on the situation information after obtaining the situation information. There may be an error in the obtained situation information. When there is an error in the situation information, the expected behavior pattern based on the situation information may also be incorrectly determined.

As described above, the electronic device may obtain situation information by itself or receive situation information from another external device. In other words, the electronic device may obtain situation information in various ways, and in the disclosure, the method of obtaining the situation information may be referred to as a “situation recognition method.”

For example, specific situation information such as “wake-up” may be received from an external device such as a smartphone, a smart watch, and a bedroom TV device, and it may be divided into a first situation recognition method, a second situation recognition method, and a third situation recognition method.

In an embodiment, the electronic device may identify that there is an error in the situation information based on receiving the user input to the first virtual button. Based on receiving the user input to the first virtual button, the electronic device may determine the situation information that is the basis for determining the current expected behavior pattern as an error, and limit the situation recognition method associated with the situation information determined as an error. Thereafter, the electronic device may not obtain situation information through the limited situation recognition method or may ignore the obtained situation information. In other words, situation information associated with the limited situation recognition method is excluded in determining the expected behavior pattern.

For example, the electronic device can determine the expected behavior pattern after receiving the situation information “wake-up” from the smartphone, but may receive a negative response according to the user input. Then, if the user input to the activated first virtual button is received, the electronic device may identify that there is an error in the situation information “wake-up”, and the situation information “wake-up” received from the smartphone that provided the situation information “wake-up” may be ignored in determining the expected behavior pattern.

Through this, the electronic device of the disclosure may post-prevent an error in determining the expected behavior pattern due to incorrect collection of situation information, and may also clearly specify whether there is an error in determining the expected behavior pattern or whether there is an error in the situation information that is the basis for the determination to thereby enable more accurate inference in the future.

In an embodiment, the electronic device may update the relationship information between the situation information and the behavior pattern based on the user input to the activated second virtual button (at block 309).

In an embodiment, the relationship information may include mapping relationships between situation information and behavior patterns. For example, situation information #1 may be mapped to behavior pattern #1 and behavior pattern #2 and, in this case, situation information #1 may form mapping relationship #1 and mapping relationship #2 with behavior pattern #1 and behavior pattern #2, respectively.

In an embodiment, the electronic device may delete any one of the plurality of mapping relationships described above. Here, the mapping relationship to be deleted may be selected based on the user input to the second virtual button.

In an embodiment, the electronic device may identify that the expected behavior pattern determined based on the situation information is incorrectly determined based on the user input to the second virtual button being received.

In an embodiment, if the user input to the second virtual button is received, the electronic device may delete the mapping relationship between the expected behavior pattern associated with the second virtual button and situation information that is the basis for determining the expected behavior pattern. For example, when “power on bedroom TV” is determined as the expected behavior pattern based on the situation information “wake-up”, but the negative response to the expected behavior pattern and a user input to the second virtual button are received sequentially, the mapping relationship between “wake-up” and “power on bedroom TV” may be deleted. Thereafter, even if “wake-up” is identified as situation information, the electronic device may not determine “power on bedroom TV” as the expected behavior pattern.

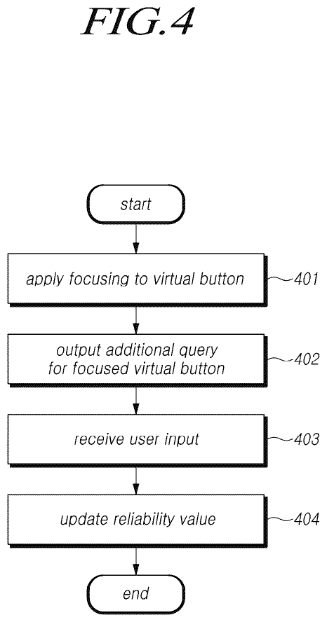

FIG. 4 is a flowchart illustrating a focusing method of a virtual button applied to FIG. 3.

The electronic device according to an embodiment of the disclosure may support the expected behavior pattern to be determined more suitable for the user according to the user input to the virtual button. However, the virtual button includes a first virtual button and a second virtual button and, as described below, may include a plurality of first virtual buttons and a plurality of second virtual buttons. In this case, it is necessary to minimize user-machine interactions for a plurality of virtual buttons.

In an embodiment, the electronic device may set priorities for the plurality of virtual buttons and lead to a user input to a virtual button with a higher priority to minimize user-machine interactions. In other words, the electronic device may set priorities for the plurality of virtual buttons, and allow focusing to be applied to a virtual button with a higher priority. The user may feel the benefit of a user convenience by selecting the automatically focused virtual button even if he does not perform the cumbersome operation of moving focusing to select any one of the plurality of virtual buttons. This is described below in detail.

In an embodiment, the electronic device may apply focusing to any one of the first virtual button and/or the second virtual button (at block 401).

In an embodiment, the electronic device may identify a reliability value associated with situation information and/or the expected behavior pattern. The reliability value may include, e.g., a first reliability value associated with the situation information and a second reliability value associated with the expected behavior pattern.

In an embodiment, the electronic device may apply focusing to either the first virtual button or the second virtual button based on the reliability value. The electronic device may compare the first reliability value with the second reliability value.

In an embodiment, when the first reliability value is larger, the electronic device may give a higher priority to the expected behavior pattern, and focusing may be applied to the second virtual button. Further, when the second reliability value is larger, the electronic device may give a higher priority to the situation information, and focusing may be applied to the first virtual button.

Meanwhile, in an embodiment, the electronic device may apply focusing to the virtual button set as having a lower priority based on receiving a positive response to the focused virtual button.

For example, the electronic device may apply focusing to the second virtual button when the first reliability value is larger, and may apply focusing to the first virtual button based on receiving a positive response to the second virtual button. Further, the electronic device may apply focusing to the first virtual button when the second reliability value is larger, and may apply focusing to the second virtual button based on receiving a positive response to the first virtual button.

In an embodiment, the electronic device may output an additional query corresponding to the focusing-applied virtual button (at block 402).

The additional query may be displayed in substantially the same manner as the above-described query. The additional query may be displayed in a text manner at the upper end of the focusing-applied virtual button, or may be outputted as a voice in audio form.

Assuming a situation where an expected behavior pattern of powering on the living room TV when returning home, the electronic device outputs a main query, such as “Welcome, do you want me to turn on living room TV?” Thereafter, if a negative response is received, the electronic device may apply focusing to any one of the first virtual button and the second virtual button and output an additional query. When focusing is applied to the first virtual button, the electronic device may output an additional query for identifying whether the situation information is correct, such as “Is it correct that you have just returned home?” Further, when focusing is applied to the second virtual button, the electronic device may output an additional query to identify whether the expected behavior pattern is correct, such as “Maybe you're running this operation?”

In an embodiment, the electronic device may receive a user input to the focusing-applied virtual button (at block 403). Focusing may relate to inquiring about and/or obtaining information from the user about a virtual button that is presented.

In an embodiment, the user input to the virtual button may include a positive response and a negative response. More specifically, the user input to the first virtual button or the second virtual button may include a positive response and a negative response.

For example, if a negative response to the first virtual button is received, the electronic device may determine that there is an error in the situation information. Further, if a negative response to the second virtual button is received, the electronic device may determine that there is an error in determining the expected behavior pattern.

In an embodiment, the reliability value may be updated based on the user input to the first virtual button or the second virtual button (at block 404).

In an embodiment, when a negative response to the first virtual button is received, the first reliability value may be decreased. Although not limited thereto, the first reliability value may be decreased only when focusing is applied to the first virtual button and a negative response to the first virtual button is received.

In an embodiment, when a positive response to the first virtual button is received, the first reliability value may be increased. Although not limited thereto, the first reliability value may be increased only when focusing is applied to the first virtual button and a positive response to the first virtual button is received.

In an embodiment, when a negative response to the second virtual button is received, the second reliability value may be decreased. Although not limited thereto, the second reliability value may be decreased only when focusing is applied to the second virtual button and a negative response to the second virtual button is received.

In an embodiment, when a positive response to the second virtual button is received, the second reliability value may be increased. Although not limited thereto, the first reliability value may be increased only when focusing is applied to the second virtual button and a positive response to the second virtual button is received.

Although not limited thereto, situation information may be obtained by processing various sensing information, and may include inaccurate processing results. Likewise, the expected behavior pattern is also determined based on the situation information and may include inaccurate determination results. The electronic device of the disclosure may simplify user-machine interaction by comparing reliability values for the respective results and identifying whether the object with a lower reliability value is correct.

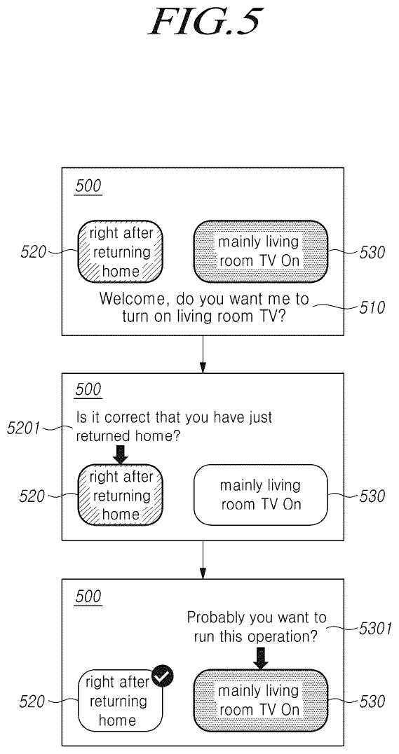

FIG. 5 is a reference view illustrating a control method according to an embodiment.

In an embodiment, the electronic device may obtain situation information. The situation information may be received from an external device, but is not limited thereto. For example, the electronic device may receive the situation information “right after returning home” from the external device.

In an embodiment, the electronic device may determine an expected behavior pattern among a plurality of behavior patterns based on identifying the situation information (“right after returning home”). For example, the electronic device may determine “power on living room TV” which is pre-mapped with the situation information (“right after returning home”) as the expected behavior pattern.

In an embodiment, the electronic device may output a user interface representation 500 including at least one of the first virtual button 520, the second virtual button 530, and/or the main query 510 through the output unit.

In an embodiment, the electronic device may output a first virtual button 520 indicating the situation information and a second virtual button 530 indicating the expected behavior pattern through the output unit. Further, the electronic device may output a main query 510 corresponding to the expected behavior pattern through the output unit. Here, the main query 510 may be composed of, e.g., a sentence such as “Welcome, do you want me to turn on living room TV?” The first virtual button 520 and the second virtual button 530 may be displayed as separate graphic objects, respectively.

In an embodiment, the electronic device may apply focusing to either the first virtual button 520 or the second virtual button 530 based on receiving a negative response to the main query 510. The electronic device may compare the first reliability value regarding the situation information and the second reliability value regarding the expected behavior pattern, setting priorities for the same. When the first reliability value is larger, a higher priority may be set to the expected behavior pattern, and when the second reliability value is larger, a higher priority may be set to the situation information.

Referring to FIG. 5, as a case where the second reliability value is larger, a higher priority may be set to the situation information. In this case, the electronic device may apply focusing to the first virtual button 520 and output an additional query 5201 for identifying whether the situation information is correct through the output unit.

When a negative response to the first virtual button 520 is received (e.g., regarding the additional query 5201), the electronic device may update the situation recognition method. This is substantially the same as described above with reference to FIG. 3. Further, when a positive response to the first virtual button 520 is received (e.g., regarding the additional query 5201), the electronic device may apply focusing to the second virtual button 530. In this case, an additional query 5301 for identifying whether the determined expected behavior pattern is correct may be output through the output unit.

Meanwhile, when the response to the first virtual button 520 is not received within a predefined time (e.g., regarding the additional query 5201), the electronic device processes the same in substantially the same manner as when the positive response is received. In other words, when a user input to the first virtual button 520 is not received within the predefined time, the electronic device may apply focusing to the second virtual button 530.

In an embodiment, when a negative response to the second virtual button 530 is received (e.g., regarding the additional query 5301), the electronic device may update the mapping relationship between the situation information and the expected behavior pattern. This is substantially the same as described above with reference to FIG. 3. Further, when a positive response to the second virtual button 530 is received (e.g., regarding the additional query 5301), the electronic device may not update the situation recognition method or relationship information. On the other hand, when a response to the second virtual button 530 is not received within the predefined time, the electronic device treats the same in substantially the same manner as the positive response is received.

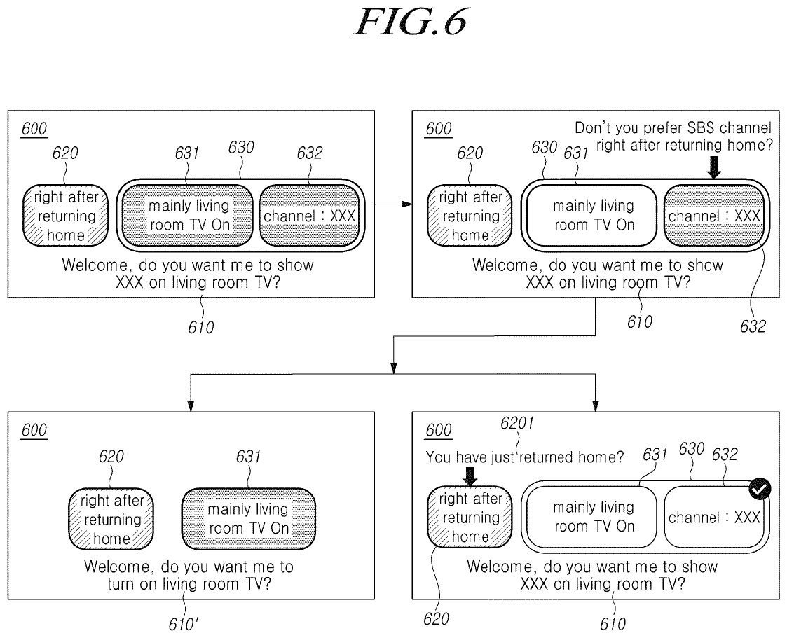

FIG. 6 is a reference view illustrating a control method according to an embodiment.

In an embodiment, the electronic device may select two or more expected behavior patterns based on situation information. In this case, the two or more expected behavior patterns may be constituted of (or include) an independent behavior pattern and one or two or more dependent behavior patterns. The independent behavior pattern refers to a behavior pattern without a prerequisite, and the dependent behavior pattern refers to a behavior pattern with a prerequisite in (before) which the independent behavior pattern or another dependent behavior pattern should be performed. The independent behavior pattern and the dependent behavior pattern may be associated with each other in a sequential relationship.

Referring to FIG. 6, “turn on living room TV” as an independent behavior pattern and “turn on channel xxx” as a dependent behavior pattern are illustrated, and the dependent behavior pattern may be performed after the independent behavior pattern is performed normally.

In an embodiment, the electronic device may output a user interface representation 600 including at least one of the first virtual button 620, the second virtual button 630, and/or the main query 610 through the output unit.

In an embodiment, the electronic device may output the main query 610.

When two or more expected behavior patterns are determined and the expected behavior patterns are associated with each other in a sequential relationship, the main query 610 may be constituted of (or include) a phrase asking whether to execute the determined two or more expected behavior patterns. For example, when “turn on living room TV” and “turn on channel xxx” are determined as the expected behavior patterns, the main question 610 may be constituted of a phrase asking whether to perform a dependent behavior pattern on the premise that an independent behavior pattern, such as “Welcome, do you want me to show SBS on living room TV?”

Meanwhile, in an embodiment, the electronic device may output the second virtual buttons 631 and 632 for the plurality of expected behavior patterns, respectively, together with the main query 610. The plurality of second virtual buttons 630 (e.g., virtual buttons 631 and 632) may be expressed to be grouped within one edge (e.g., within one displayable object), but are not limited thereto.

In an embodiment, when the electronic device receives a negative response to the main query 610, the electronic device may not execute the expected behavior patterns in response to receiving the negative response.

In an embodiment, the electronic device may activate the virtual buttons 620 and 630 based on receiving a negative response to the main query 610. In this case, the virtual button may include a plurality of second virtual buttons 630 as well as a first virtual button 620.

In an embodiment, the electronic device may apply focusing to any one of the plurality of second virtual buttons 630. In an embodiment, the electronic device may identify second reliability values respectively associated with the plurality of second virtual buttons 630. The electronic device may apply focusing to any one of the plurality of second virtual buttons 630 by comparing the plurality of second reliability values. An increase and a decrease in the second reliability value may be understood with reference to those described above with reference to FIGS. 3 and 4.

In an embodiment, the sizes of the first reliability value and the second reliability value may be set based on the sequential relationship. In an embodiment, the independent behavior pattern may have a higher reliability value than the dependent behavior pattern (first reliability value >second reliability value). Accordingly, the electronic device may preferentially apply focusing to the second virtual button 632 corresponding to the dependent behavior pattern.

In an embodiment, if a negative response to the second virtual button 632 corresponding to the dependent behavior pattern is received, the electronic device may update a mapping relationship between the situation information and the expected behavior patterns. For example, it is possible to delete the mapping relationship between the dependent behavior pattern and the situation information, and to maintain only the mapping relationship between the independent behavior pattern and the situation information. Accordingly, if the situation information is identified thereafter, the electronic device may determine only the independent behavior pattern as the expected behavior pattern. For example, in a case where the mapping relationship between the dependent behavior pattern and the situation information is deleted, when the same situation information is identified, only the second virtual button 631 corresponding to the independent behavior pattern and the main query 610′ associated with the independent behavior pattern may be output through the output unit.

In an embodiment, if a positive response to the second virtual button 632 corresponding to the dependent behavior pattern is received, the electronic device may apply focusing to the first virtual button 620. If a positive response to the first virtual button 620 is received, the electronic device may not update the relationship information or the situation recognition method. If a negative response to the first virtual button 620 is received, the electronic device may update the situation recognition method.

In an embodiment, when a positive response to the second virtual button 632 corresponding to the dependent behavior pattern is received, the electronic device may not apply focusing to the second virtual button 631 corresponding to the independent behavior pattern. Although not limited thereto, if the electronic device receives a positive response to the second virtual button 632 corresponding to the dependent behavior pattern, the electronic device may process it as a negative response having been received even for the second virtual button 631 corresponding to the independent behavior pattern.

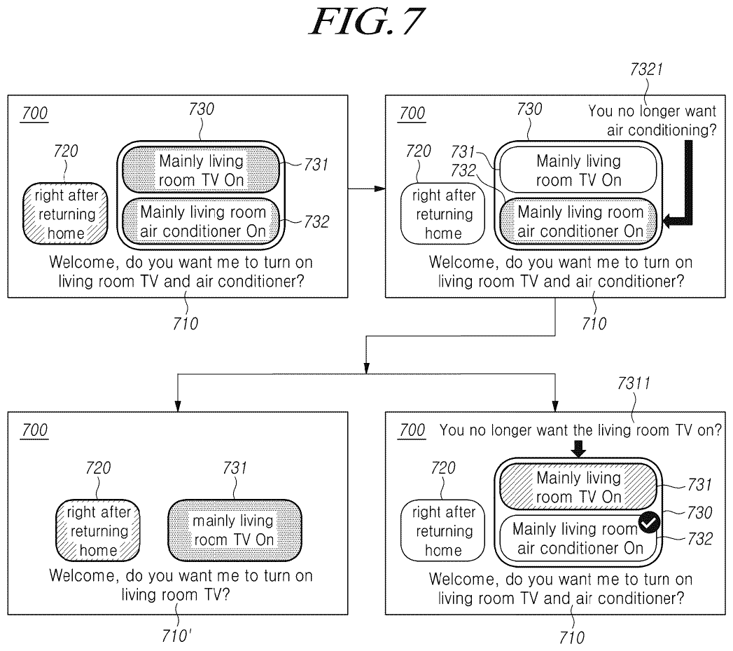

FIG. 7 is a reference view illustrating a control method according to an embodiment.

In an embodiment, the electronic device may select two or more expected behavior patterns based on situation information, and in this case, the two or more expected behavior patterns all may be formed of independent behavior patterns.

In an embodiment, the electronic device may output a user interface representation 700 including at least one of the first virtual button 720, the second virtual button 730, and/or the main query 710 through the output unit.

Referring to FIG. 7, “turn on living room TV” as an independent behavior pattern and “turn on the living room air conditioner” as another independent behavior pattern are illustrated, and the respective performances of the independent behavior patterns do not affect each other.

In an embodiment, the electronic device may output the main query 710.

When two or more expected behavior patterns are determined and each of the expected behavior patterns is an independent behavior pattern, the main query 710 may be constituted of a phrase asking whether to execute the two or more expected behavior patterns. For example, when “turn on living room TV” and “turn on the living room air conditioner” are determined as the expected behavior patterns, the main query 710 may be constituted of a phrase asking whether to execute all of the expected behavior patterns, such as “Welcome, do you want me to turn on living room TV and air conditioner?”

In an embodiment, the electronic device may output the second virtual buttons 730 for each of the plurality of expected behavior patterns together with the main query 710. The plurality of second virtual buttons 730 may be expressed to be grouped within one edge (e.g., within one displayable object), but are not limited thereto.

In an embodiment, the electronic device may activate virtual buttons based on receiving a negative response to the main query 710. In this case, the virtual button may include a plurality of second virtual buttons 730 as well as a first virtual button 720.

In an embodiment, the electronic device may apply focusing to any one of the plurality of second virtual buttons 730. In an embodiment, the electronic device may identify second reliability values respectively associated with the plurality of independent behavior patterns. The electronic device may apply focusing to any one of the plurality of second virtual buttons 730 by comparing the plurality of second reliability values. An increase and a decrease in the second reliability value may be understood with reference to those described above with reference to FIGS. 3 and 4.

Referring to FIG. 7, a situation in which the electronic device applies focusing to the second virtual button 732 (of the plurality of second virtual buttons 730) corresponding to the plurality of second independent behavior patterns is illustrated. The electronic device applies focusing to the second virtual button 732 corresponding to the second independent behavior pattern, and may output an additional query 7321 (e.g., “You no longer want air conditioning?”) for identifying whether the second independent behavior pattern is correct.

In an embodiment, if a negative response to the second virtual button 732 corresponding to the second independent behavior pattern is received, the electronic device may update a mapping relationship between the situation information and the second independent behavior pattern. For example, the mapping relationship between the situation information and the second independent behavior pattern may be deleted, while only the mapping relationship between the remaining independent behavior patterns (e.g., the first independent behavior pattern) may be maintained. Referring back to FIG. 7, when the mapping relationship between the situation information and the second independent behavior pattern is deleted, the electronic device outputs only the second virtual button 732 corresponding to the first independent behavior pattern when the same situation information is thereafter identified. In this case, as the mapping relationship between the second independent behavior pattern and the situation information is deleted, the main question 710′ is composed of a phrase associated with the first independent behavior pattern and the situation information, and the phrase related to the second independent behavior pattern may be omitted.

In an embodiment, if a positive response to the second virtual button 732 (of the plurality of second virtual buttons 730) corresponding to the second independent behavior pattern is received, the electronic device may apply focusing to the first virtual button 731 (of the plurality of second virtual buttons 730) corresponding to the first independent behavior pattern. Further, the electronic device may output an additional query 7311 (e.g., “you no longer want living room TV on?”) to identify whether the first independent behavior pattern is correct.

In an embodiment, if positive responses to all of the independent behavior patterns (e.g., the first independent behavior pattern and the second independent behavior pattern) constituting the expected behavior patterns, the electronic device may apply focusing to the first virtual button 720.

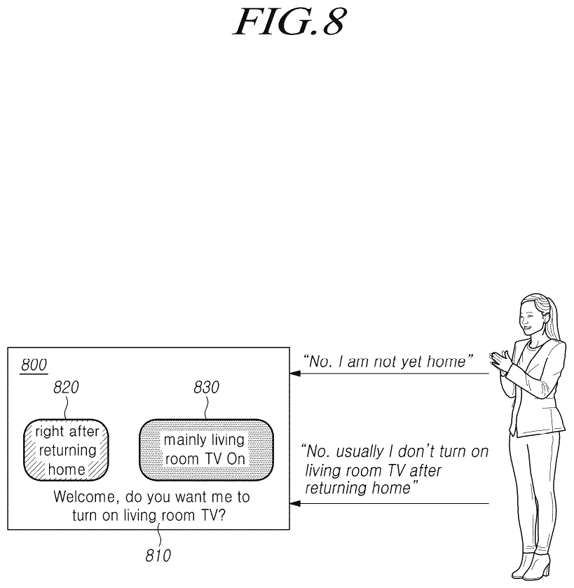

FIG. 8 is a reference view illustrating a voice control method according to an embodiment.

In an embodiment, the electronic device may output a user interface representation 800 including at least one of the first virtual button 820, the second virtual button 830, and/or the main query 810 through the output unit.

In an embodiment, the electronic device may receive a user input in response to the main query 810. In an embodiment, the key input may be included in the control signal. For example, the electronic device may detect the user's voice through a microphone electrically connected thereto or provided therein and receive the user input in the form of a voice. In this case, the voice is converted into a text form, and the electronic device may identify the user intention.

In an embodiment, the user input in the form of a voice may include a detailed response to each of the expected behavior pattern and/or the situation information. For example, the detailed response may include a first detailed response related to the situation information and a second detailed response related to the expected behavior pattern.

Referring to FIG. 8, the situation information is identified as “right after returning home”, the expected behavior pattern is identified as “turn on living room TV”, and the electronic device outputs a main query 810, such as “Welcome, do you want me to turn on living room TV?”

In an embodiment, the user input may include a first detailed response (e.g., Didn't you return home) related to the situation information (e.g., right after returning home). The electronic device may extract text associated with the situation information from the user input, and identify the first detailed response as a negative response or a positive response based on the extracted text. In an embodiment, if (a) a keyword (e.g., “return home”) corresponding to the situation information and (b) a negative word (e.g., “nope,” “no,” “don't”) at a location adjacent to the keyword are identified from the user input, the electronic device may identify the first detailed response as a negative response. For example, under the assumption that “No, I am not yet home” is the user input, the electronic device may identify “return home” and “No” located adjacent to “return home” as the keywords corresponding to the situation information. The electronic device may identify the user's intention as a negative response based on the situation of the user input. In contrast, (a) a keyword (e.g., “return home”) corresponding to the situation information and (b) a positive word (e.g., “yes,” “right,” or “yep”) located adjacent to the keyword are identified from the user input, the electronic device may identify the first detailed response as a positive response.

In an embodiment, the user input may include a second detailed response (e.g., I usually don't turn on TV after returning home) related to the expected behavior pattern (e.g., power on the TV). The electronic device may extract text associated with the situation information and the expected behavior pattern from the user input, and identify the second detailed response as a negative response or a positive response based on the extracted text. In an embodiment, if (a) a first keyword (e.g., “turn . . . TV,” or “turn . . . air conditioner”) corresponding to the expected behavior pattern, (b) a second keyword (e.g., “return home”) corresponding to the situation information, and (c) a negative word (e.g., “nope,” “no,” or “don't”) located adjacent to the first keyword are identified from the user input, the electronic device may identify the second detailed response as a negative response. For example, under the assumption that “No. usually I don't turn on living room TV after returning home” is the user input, the electronic device may identify “turn on living room TV” as the first keyword, “return home” as the second keyword, and “don't” as a negative word adjacent to the first keyword. The electronic device may identify the user's intention as a negative response based on the situation of the user input.

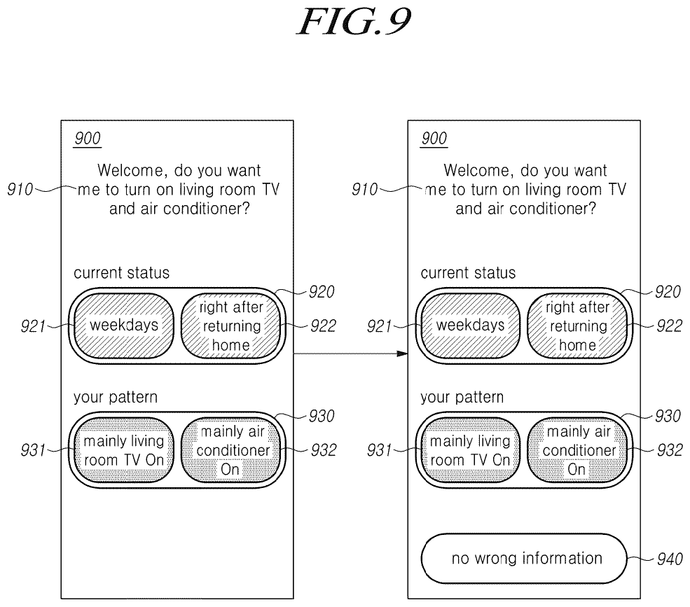

FIG. 9 is a reference view illustrating a control method according to an embodiment.

In an embodiment, the user input may be received in the form of a touch input to the touch screen. The electronic device may display a user interface representation 900 for receiving a touch input on the display. The user interface representation may include at least one of one or more first virtual buttons 920 related to situation information and one or more second virtual buttons 930 related to the expected behavior pattern.

In an embodiment, the number of the first virtual buttons may be determined based on the number of obtained situation information. For example, when the situation information is constituted of “weekdays” for time and “right after returning home” for whether to return home/go out, the first virtual buttons 921 and 922 for each situation information may be included in the user interface representation 900.

In an embodiment, the number of second virtual buttons may be determined based on the determined number of expected behavior patterns. For example, when the expected behavior pattern is determined as “mainly living room TV On” and “mainly air conditioner On,” the second virtual buttons 931 and 932 for each expected behavior pattern may be included in the user interface representation 900.

In an embodiment, the electronic device may output the main query 910. Further, the user interface representation 900 may include the main query 910. In response to receiving a negative response to the main query 910, the electronic device may activate the first virtual buttons 920 and the second virtual buttons 930.

In an embodiment, when receiving a touch input to the first virtual buttons 920, the electronic device may identify the touch input as a negative response. Further, when the electronic device receives a touch input to the second virtual buttons 930, the touch input may be identified as a negative response.

In an embodiment, the user interface representation 900 may further include a third virtual button 940 for not updating the situation recognition method or relationship information. The third virtual button 940 may be represented on the user interface representation 900 based on receiving a negative response to the main query 910.

The electronic device according to various embodiments may be one of various types of electronic devices. The electronic devices may include, for example, a display device, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the situation clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the situation. Similarly, “if A is determined” or “if A is detected” may be interpreted as “upon determining A” or “in response to determining A”, or “upon detecting A” or “in response to detecting A”, depending on the situation.

The program executed by the electronic device 10, 11, 12, or 13 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method for control by an electronic device, comprising:
obtaining situation information through a predefined situation recognition method;
determining any one of a plurality of behavior patterns as an expected behavior pattern based on the situation information;
generating a main query based on at least one of the situation information and the expected behavior pattern;
outputting, on a display, a first virtual button corresponding to the situation information, a second virtual button corresponding to the expected behavior pattern, and the main query;
activating the first virtual button and the second virtual button based on receiving a negative response to the main query; and
updating any one of a mapping relationship between the situation information and the expected behavior pattern or the predefined situation recognition method based on a user input to the first virtual button or the second virtual button.

2. The method of claim 1, wherein the user input to the first virtual button or the second virtual button includes a positive response or a negative response,
wherein the predefined situation recognition method is updated based on the user input to the first virtual button including the negative response, and
wherein the mapping relationship is updated based on the user input to the second virtual button including the negative response.

3. The method of claim 1, further comprising:
identifying a first reliability value related to the situation information and a second reliability value related to the expected behavior pattern; and
applying focusing to any one of the first virtual button or the second virtual button based on the first reliability value and the second reliability value.

4. The method of claim 3, wherein applying the focusing includes:
applying the focusing to the second virtual button based on the first reliability value being larger than the second reliability value; and
applying the focusing to the first virtual button based on the second reliability value being larger than the first reliability value.

5. The method of claim 4, further comprising, based on another user input to the focusing applied to the first virtual button or the second virtual button including a positive response, applying the focusing to another virtual button of the first virtual button or the second virtual button.

6. The method of claim 1, wherein the situation information is received from an external device or obtained based on sensing information by one or more sensors.

7. The method of claim 1, wherein the plurality of behavior patterns include at least one of one or more operations for controlling a behavior of the electronic device or one or more operations for controlling a behavior of another device connected to the electronic device through a network.

8. The method of claim 1, wherein the expected behavior pattern includes at least one of an independent behavior pattern or a dependent behavior pattern, and wherein the dependent behavior pattern is performed with a lower priority than the independent behavior pattern.

9. The method of claim 1, further comprising, when the expected behavior pattern includes two or more independent behavior patterns, outputting, on the display, two or more second virtual buttons respectively corresponding to the two or more independent behavior patterns.

10. The method of claim 9, further comprising, based on receiving a negative response to any one of the two or more second virtual buttons, deleting another mapping relationship between the situation information and a one of the two or more independent behavior patterns associated with the any one of the two or more second virtual buttons where the negative response is received.

11. The method of claim 8, further comprising, when the expected behavior pattern includes the independent behavior pattern and one or more dependent behavior patterns, outputting, on the display, two or more second virtual buttons respectively corresponding to the independent behavior pattern and the one or more dependent behavior patterns dependent on the independent behavior pattern.

12. The method of claim 11, further comprising:
applying focusing to one of the two or more second virtual buttons corresponding to any one of the one or more dependent behavior patterns;
receiving a negative response to the one of the two or more second virtual buttons having the focusing applied; and
deleting the mapping relationship between the situation information and the any one of the one or more dependent behavior patterns associated with the one of the two or more second virtual buttons where the negative response is received.

13. The method of claim 11, further comprising:
applying focusing to one of the two or more second virtual buttons corresponding to any one of the one or more dependent behavior patterns;
receiving a positive response to the one of the two or more second virtual buttons having the focusing applied; and
applying the focusing to the first virtual button based on receiving the positive response.

14. The method of claim 11, further comprising:
applying focusing to one of the two or more second virtual buttons corresponding to any one of the one or more dependent behavior patterns;
receiving a positive response to the one of the two or more second virtual buttons having the focusing applied; and
applying the focusing to the first virtual button without applying the focusing to another second virtual button corresponding to the independent behavior pattern based on receiving the positive response.

15. An electronic device, comprising:
a display, one or more memories, one or more transceivers, and one or more processors electrically connected to the display, the one or more memories, and the one or more transceivers, wherein the one or more memories store instructions that, when executed by the one or more processors individually or collectively, cause the electronic device to perform operation comprising:
obtaining situation information through a predefined situation recognition method;
determining any one of a plurality of behavior patterns as an expected behavior pattern based on the situation information;
generating a main query based on at least one of the situation information and the expected behavior pattern;
outputting, on the display, a first virtual button corresponding to the situation information, a second virtual button corresponding to the expected behavior pattern, and the main query;
activating the first virtual button and the second virtual button based on receiving a negative response to the main query; and
updating any one of a mapping relationship between the situation information and the expected behavior pattern or the predefined situation recognition method based on a user input to the first virtual button or the second virtual button.

16. The electronic device of claim 15, wherein:
the user input to the first virtual button or the second virtual button includes a positive response or a negative response;
the predefined situation recognition method is updated based on the user input to the first virtual button including the negative response, and
the mapping relationship is updated based on the user input to the second virtual button including the negative response.

17. The electronic device of claim 15, wherein the instructions cause the electronic device to perform the operation further comprising:
identifying a first reliability value related to the situation information and a second reliability value related to the expected behavior pattern; and
applying focusing to any one of the first virtual button or the second virtual button based on the first reliability value and the second reliability value.

18. The electronic device of claim 17, wherein applying the focusing includes:
applying the focusing to the second virtual button based on the first reliability value being larger than the second reliability value; and
applying the focusing to the first virtual button based on the second reliability value being larger than the first reliability value.

19. The electronic device of claim 18, wherein the instructions cause the electronic device to perform the operation further comprising, based on another user input to the focusing applied to the first virtual button or the second virtual button including a positive response, applying the focusing to another virtual button of the first virtual button or the second virtual button.

20. The electronic device of claim 15, wherein the situation information is received from an external device or obtained based on sensing information by one or more sensors.
